(19) United States
(12) Patent Application Publication
(10) Pub. No.: US 2014/0240714 A1
(43) Pub. Date: Aug. 28, 2014

(54) OPTICAL COHERENCE TOMOGRAPHIC IMAGING INFORMATION ACQUISITION APPARATUS

(71) Applicant: CANON KABUSHIKI KAISHA, Tokyo (JP)

(72) Inventors: Toshimitsu Matsuu, Yokohama-shi (JP); Takeshi Uchida, Tokyo (JP)

(21) Appl. No.: 14/352,037

(22) PCT Filed: Oct. 12, 2012
(86) PCT No.: PCT/JP2012/077017

§ 371 Date: Apr. 15, 2014

(30) Foreign Application Priority Data
Oct. 24, 2011 (JP) 2011-232492

(51) Int. Cl. G01B 9/02

(52) U.S. Cl. CPC G01B 9/02091
USPC 356/479

(57) ABSTRACT

An optical tomographic imaging information acquisition apparatus according to an SD-OCT system including: at least two super luminescent diodes; a sensor and a spectrometer that are for acquiring information on a measurement target; a combiner section for the photoreceptor unit configured to combine emitted beams from the at least two super luminescent diodes (SLDs) and to guide the beams to the photoreceptor unit; a monitor unit configured to monitor a spectrum of the emitted beams from the at least two super luminescent diodes; a driving unit configured to drive the SLDs; and a control unit configured to feed back a monitored result by the monitor unit to the driving unit, the driving unit is further configured to drive only one of each of the at least two super luminescent diodes. With the apparatus, a spectral shape can be easily controlled to be unimodal.

### TECHNICAL FIELD

The present invention relates to an optical coherence tomographic imaging information acquisition apparatus according to a spectral domain method, and particularly to an optical coherence tomographic imaging information acquisition apparatus using super luminescent diodes (SLDs).

### BACKGROUND ART

For acquiring an optical tomography image of living body tissue, an optical coherence tomographic imaging information acquisition apparatus according to an optical coherence tomography (OCT) system is used. An optical tomographic imaging information acquisition apparatus according to the spectral domain OCT (SD-OCT) system, which is one of the optical coherence tomographic imaging information acquisition apparatuses, can acquire a tomographic image of a living body using a reflected light intensity distribution in the depth direction. More specifically, low coherence light emitted from an optical source is split into measuring beams and reference beams, interfering beams of reflected measuring beams and reference beams are spectroscopically analyzed, and spectral information is acquired by a line sensor. Fourier transform is performed on the information, thereby a reflected light intensity distribution of a living body in the depth direction can be acquired.

It has been known that, as an optical source required for this system, wide-band low coherence light can be adopted to improve resolution.

Furthermore, it has been also known that the spectral shape may desirably be unimodal. Deviation from unimodality degrades signal noise ratio (SNR) after Fourier transform and causes blurring of a tomographic image. The degradation and blurring are causes of quality degradation of acquired tomographic images.

Thus, a wide-band and unimodal spectral shape is required for an optical source of an optical tomographic imaging information acquisition apparatus according to the SD-OCT system. For the sake of the above, adoption of SLDs including semiconductor elements is considered. SLDs are elements that have a wide-band spectral shape as with a light emitting diode and can acquire an optical output of at least 1 mW as with semiconductor lasers.

A method of acquiring a wide-band spectrum in an SLD may be to provide an active layer with an asymmetric multiple quantum well (A-MQW) structure having different light emitting wavelengths. However, even with this structure, a wide-band and unimodal spectrum and a high optical output are difficult to be achieved at the same time. For instance, if a wide-band spectrum is achieved, the spectral shape becomes asymmetric.

Japanese Patent Application Laid-Open No. 2007-149808 (hereinafter also called “PTL 1”) discloses one of methods of simultaneously achieving them that, multiple SLDs are combined to achieve a high optical output and a wide-band spectrum, which has been difficult to be realized by only one SLD.

For acquiring an optical tomography image by the SD-OCT system, SLDs may be used in a combined manner as an optical source having a wide-band spectrum.

The spectral shape is important for image quality of an acquired tomographic image. Accordingly, a spectral shape is required to be monitored and subjected to feedback during acquisition of a tomographic image in order to control the spectral shape. In the case of combining SLDs as described above, when temperature variation varies the spectral shape, it is required to monitor the spectral shape of each one of SLDs, not the spectral shape after combination of the SLDs. However, if monitors are provided for the respective SLDs, the cost is increased. Therefore, it is desirable to use one monitor for monitoring emitted beams from each of at least two SLDs.

Unfortunately, in the case of monitoring the spectral shapes of emitted beams from at least two SLDs simultaneously with acquiring a tomographic image by one monitor, although the spectral shape after combination can be monitored, the spectral shape of each one of the SLDs cannot be monitored. Therefore, it has been difficult to control the spectral shape simultaneously with acquiring a tomographic image.

### CITATION LIST

### Patent Literature

PTL 1: Japanese Patent Application Laid-Open No. 2007-149808

### SUMMARY OF INVENTION

In view of the problem, it is an object of the present invention to provide an optical tomographic imaging information acquisition apparatus according to an SD-OCT system that can, during monitoring of the spectral shapes of emitted beams from at least two SLDs by one monitor, control the spectral shape simultaneously with acquiring an optical tomography image.

An optical coherence tomographic imaging information acquisition apparatus according to the present invention includes: an optical source section including at least two super luminescent diodes; a photoreceptor unit including a sensor and a spectrometer that are for acquiring information on a measurement target; a combiner section for the photoreceptor unit configured to combine emitted beams from the at least two super luminescent diodes that are emitted from one end of the optical source section and to guide the beams to the photoreceptor unit; a monitor unit configured to monitor a spectrum of the emitted beams from the at least two super luminescent diodes in the optical source section; a driving unit configured to drive the SLDs; and a control unit configured to feed back a monitored result by the monitor unit to the driving unit, in which the driving unit is further configured to drive, in any photoreception cycle among photoreception cycles, each of which are a cycle time in which the sensor reads a signal, only one of each of the at least two super luminescent diodes.

The present invention can realize an optical coherence tomographic imaging information acquisition apparatus according to a spectrum domain principle that can, during monitoring of the spectral shapes of emitted beams from at least two SLDs by one monitor, control the spectral shape simultaneously with acquiring an optical tomography image.

Further features of the present invention will become apparent from the following description of exemplary embodiments with reference to the attached drawings.

### BRIEF DESCRIPTION OF DRAWINGS

FIG. 1 is a diagram illustrating an example of the configuration of an optical tomographic imaging information acquisition apparatus according to an SD-OCT system in Example 1 of the present invention.

FIG. 2 is a diagram illustrating a method of driving SLDs in Example 1 of the present invention.

FIG. 3 is a schematic sectional view illustrating a layer configuration of an optical output unit in Example 1 of the present invention.

FIG. 4 is a perspective view illustrating a structure of the optical output unit in Example 1 of the present invention.

FIG. 5 is a spectrogram in the case of adopting A-MQW as an active layer of the SLD in Example 1 of the present invention.

FIG. 6 is a diagram illustrating a specific configuration of a photoreceptor unit 150 in FIG. 1 that is applied to the SD-OCT system in Example 1 of the present invention.

FIG. 7 is a diagram illustrating an example of the configuration of an optical tomographic imaging information acquisition apparatus according to the SD-OCT system in Example 2 of the present invention.

FIG. 8 is a diagram illustrating a method of driving SLDs in Example 2 of the present invention.

FIG. 9 is a diagram illustrating a method of driving SLDs in Example 3 of the present invention.

FIG. 10 is a diagram illustrating an example of the configuration of an optical tomographic imaging information acquisition apparatus according to an SD-OCT system in Example 4 of the present invention.

FIG. 11 is a diagram illustrating a method of driving SLDs in Example 4 of the present invention.

### DESCRIPTION OF EMBODIMENTS

In the present invention, an optical coherence tomographic imaging information acquisition apparatus according to an SD-OCT (spectral domain OCT) controls, during monitoring of the spectral shapes of emitted beams from the SLDs by one monitor, driving of at least two SLDs as described below. Thus, the spectral shape can be controlled simultaneously with acquiring an optical tomography image.

The SD-OCT system in the embodiment of the present invention includes: an optical source section including at least two SLDs configured to acquire low coherence, wide-band and unimodal spectrum; and a line sensor onto which light from the optical source section is incident and which acquires information on a measurement target. The system further includes: a photoreceptor unit including a spectrometer; a monitor unit including a monitor configured to monitor emitted beams from the at least two SLDs in one monitor; combiner section for the photoreceptor unit configured to guide emitted beams from the at least two SLDs to the photoreceptor unit; a control unit configured to feed back a monitored result to a driving unit; and the driving unit configured to drive each SLD.

In a conventional system, the spectra of the respective SLDs cannot be monitored simultaneously with acquiring a tomographic image, i.e. combining emitted beams from at least two SLDs, in the same monitor. Meanwhile, this embodiment solves the problem by the above configuration and driving method of a driving unit.

To describe a unit for implementation, a principle of acquiring a tomographic image in the SD-OCT system will be described.

As described above, the SD-OCT system splits emitted beams from the optical source into measuring beams and reference beams, and subsequently, spectroscopically analyzes interfering beams of reflected measuring beams and reference beams, causes the line sensor to acquire spectral information, and performs Fourier transform, thereby acquiring a reflected light intensity distribution of a living body in the depth direction. Here, the line sensor for acquiring spectral information in the photoreceptor unit has a mechanism that charges according to incident light are stored for a predetermined time, and the amounts of charges are read after the predetermined time has elapsed. Therefore, the amounts of charges to be read are integrated values of the optical outputs, and if the incident optical output varies during the charge storing time, individual optical outputs cannot be read. That is, in the SD-OCT system, the spectral shape is determined by the amount of light integrated in a carrier storing time of the line sensor, i.e. in a photoreception cycle, which is a cycle time in which the line sensor reads a signal.

Thus, in this embodiment, based on the operation principle of a line sensor, the driving unit for driving each SLD is configured as above to adjust driving current and drive time as necessary so as to acquire a desired spectrum in a photoreception cycle without simultaneously driving at least two SLDs, and drives these SLDs. Furthermore, a configuration is adopted that time is secured for driving each one of at least two SLDs instead of simultaneously driving the SLDs in any one of photoreception cycles, which is a cycle time in which the line sensor reads a signal.

Due to this configuration, the desired spectrum can be acquired in the photoreception cycle, and the spectrum can be monitored in time for driving only one of the SLDs. Thus, the single monitor can monitor the spectrum of each SLD simultaneously with acquisition of a tomographic image.

Hereinafter, Examples of the present invention will be described.

### Example 1

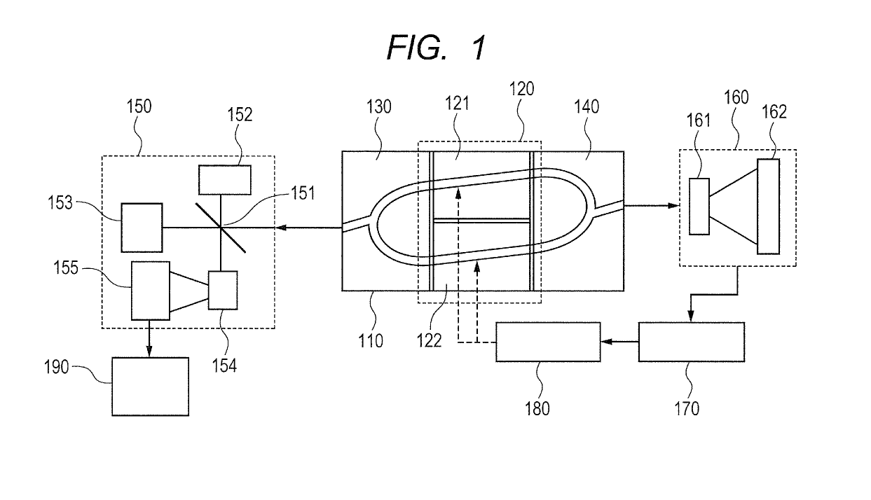

As illustrated in FIG. 1, an SD-OCT system in an example of the configuration of an optical tomographic imaging information acquisition apparatus according to an SD-OCT system to which the present invention is applied in Example 1 includes: an optical source section 120 including two SLDs (SLDs 121 and 122) emitting beams in two directions, at one end and the other end; and a photoreceptor unit 150 including an optical splitter 151, a reference beam reflector 152, a measurement section 153, a spectrometer 154 and a line sensor 155.

This SD-OCT system further includes: a monitor unit 160 that includes a spectrometer 161 and a line sensor 162 and that monitors the spectra of emitted beams from the SLDs 121 and 122; a combiner section 130 for the photoreceptor unit that guides the emitted beams from the SLDs 121 and 122 to the photoreceptor unit 150; a combiner section 140 for the monitor unit that guides emitted beams from the SLDs 121 and 122 to the monitor unit 160; a control unit 170 that feeds back a monitored result by the monitor unit 160 to a driving unit 180; the driving unit 180 that drives each one of the SLDs 121 and 122 in turn such that the drive time of the SLDs 121 and 122 in a photoreception cycle does not overlap with each other; and an image converter unit 190 that converts spectral information acquired by the photoreceptor unit 150 into an image. According to the configuration of this Example, the emitted beams from each SLD in the two directions are used for acquiring a tomographic image and monitoring spectra, thereby allowing acquiring the tomographic image and monitoring the spectra simultaneously with each other without using a splitter unit.

In this Example, the optical output unit 110, which includes the optical source section 120, the combiner section 130 for the photoreceptor unit and the combiner section 140 for the monitor unit, is fabricated on the same substrate. An integrated twin guide structure and a Y-branch waveguide structure are adopted, thereby combining the emitted beams from the SLDs 121 and 122 into one output section.

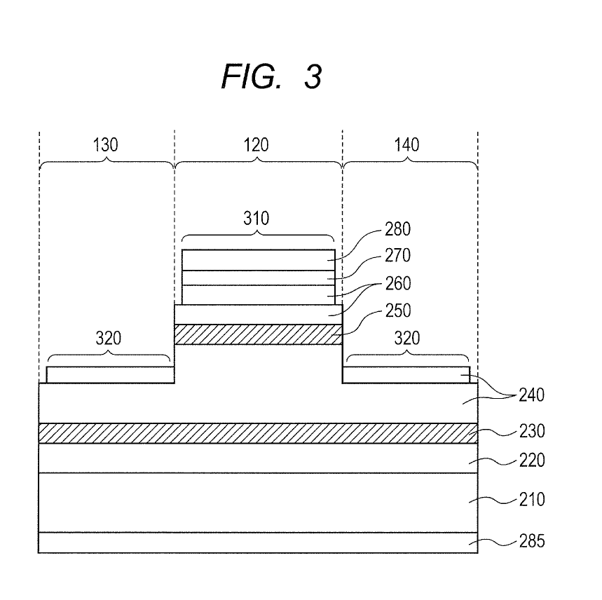

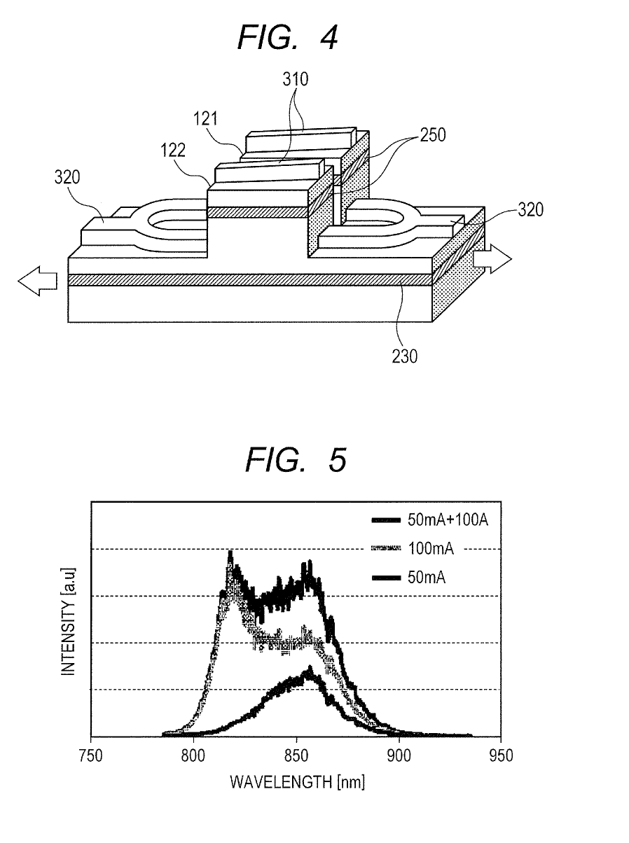

To illustrate the layer configuration of this structure, FIG. 3 illustrates a sectional view of a layer configuration of the optical source section 120, the combiner section 130 for the photoreceptor unit, and the combiner section 140 for the monitor unit; and FIG. 4 illustrates a perspective view thereof.

In this Example, on an n-type GaAs substrate 210, n-Al_{0.5}GaAs as an n-type cladding layer 220, Al_{0.2}GaAs as a waveguide layer 230, n-Al_{0.5}GaAs as an n-type cladding layer 240, InGaAs/Al_{0.2}GaAs, GaAs/Al_{0.2}GaAs and AlGaAs/Al_{0.2}GaAs quantum wells using three asymmetric multiple quantum wells as an active layer 250, p-Al_{0.5}GaAs as a p-type cladding layer 260, and high-doped p-GaAs as a contact layer 270, are stacked.

On the upper part of the contact layer, an upper electrode 280 is provided. On the lower surface of the substrate, a lower electrode 285 is provided. Ti/Au is adopted as the upper electrode 280. AuGe/Ni/Au is adopted as the lower electrode 285.

In the case of adopting an asymmetric multiple quantum well as the active layer 250, a spread and a change in shape of the spectrum are identified according to difference in the amount of injected current, as described in IEEE J. Quantum Electronics, Vol. 42, No. 12, pp. 1256-1262, 2008.

As illustrated in FIG. 4, as to the element structure, the SLDs 121 and 122 include ridges 310. In portions other than the ridge 310, the contact layer 270 and a part of the p-type cladding layer 260 are removed up to a certain depth. The SLDs 121 and 122 are separated by etching up to a certain depth in the n-type cladding layer 240 below the active layer 250. Furthermore, a Y-branch waveguide 320 is formed by partial etching up to a certain depth in the n-type cladding layer 240.

The ridge width of each of the SLDs 121 and 122 is 3 μm, and the ridge length thereof is 0.5 mm. The ridge 310 is inclined by seven degrees with respect to a perpendicular line of an end surface of the ridge and the longitudinal direction of the ridge so as to prevent reflection on the end surface of the ridge. In each of the combiner section 130 for the photoreceptor unit and the photoreceptor section 140 for the monitor unit, each angle of portions of the Y-branch waveguide 320 connected to the SLDs 121 and 122 is inclined by an inclination angle analogous to the inclination angle of each of SLDs 121 and 122; here, the angle is seven degrees. Furthermore, the output sections of the combiner section 130 for the photoreceptor unit and the photoreceptor section 140 for the monitor unit on the sides of the photoreceptor unit 150 and the monitor unit 160, respectively, are also inclined by seven degrees.

To control reflectivity, multilayered dielectric films may be added onto both the end surfaces of the output sections of the combiner section 130 for the photoreceptor unit and the photoreceptor section 140 for the monitor unit on the sides of the photoreceptor unit 150 and the monitor unit 160, respectively.

The structures of the combiner section 130 for the photoreceptor unit and the combiner section 140 for the monitor unit are identical to each other. Furthermore, the properties of the beams in the two directions emitted from the SLDs 121 and 122 can be identical to each other. Thus, an optical output used for acquiring a tomographic image and an optical output for monitoring become identical to each other, thereby allowing simpler feedback.

The element can be fabricated according to the following procedures.

First, on the GaAs substrate 210, a semiconductor layer configuration is sequentially grown as follows. That is, the n-type cladding layer 220, the waveguide layer 230, the n-type cladding layer 240, the active layer 250, the p-type cladding layer 260 and the contact layer 270 are sequentially grown using, for instance, metal organic chemical vapor deposition (MOCVD) method. On a wafer where each layer is stacked, the ridges 310 are formed using semiconductor lithography and semiconductor etching. For instance, a dielectric film of, e.g. SiO₂, is formed using sputtering, and subsequently, a stripe forming mask for forming the ridges by a photoresist is formed using semiconductor lithography. Here, portions of semiconductor other than the stripe forming mask are selectively removed using dry etching. At this time, the portions to be removed are up to a certain depth in the p-type cladding layer 260. For instance, ridge shapes having a depth of 0.8 μm are formed.

Subsequently, a dielectric film of, e.g. SiO₂, is formed on the surface of the semiconductor, and the SiO₂ on the ridge 310 and the SiO₂ at portions other than those where the SLDs 121 and 122 are to be formed are partially removed by photolithography. Next, the upper electrode 280 is formed on the upper part of each of the SLDs 121 and 122 using vacuum deposition and lithography. The upper electrode 280 is, for instance, Ti/Au. Next, the semiconductor layers other than the upper portions of the SLDs 121 and 122 are removed using photolithography and dry etching. Here, the SLDs 121 and 122 are separated by etching up to a certain depth in the n-type cladding layer 240 between the active layer 250 and the waveguide layer 230. Furthermore, the semiconductor layers other than the SLDs 121 and 122 and the Y-branch waveguide 320 are removed using photolithography and dry etching. Etching is performed up to a certain depth in the n-type cladding layer 240 between the active layer 250 and the waveguide layer 230. Thus, the integrated twin guide and the Y-branch waveguide, in which beams generated by the SLDs 121 and 122 can be guided into the output sections on the sides of the photoreceptor unit 150 and the monitor unit 160, are formed. The lower electrode 285 is then formed. The lower electrode 285 is, for instance, AuGe/Ni/Au. To acquire favorable electric properties, the electrodes and semiconductor are alloyed with each other in a high-temperature nitrogen atmosphere. Finally, crystal faces are exposed on the end surfaces by cleavage, and dielectric films for adjusting reflectivity are coated on both the end surfaces, thus completing the element.

Emitted beams from the SLDs 121 and 122 of the thus fabricated optical output unit 110 are incident onto the photoreceptor unit 150 and the monitor unit 160 using optical fibers. The photoreceptor unit 150 acquires a tomographic image using the incident beams. The monitor unit 160 monitors the spectra of the SLDs 121 and 122. Based on monitored results by the monitor unit 160, the control unit 170 controls driving current for the SLDs 121 and 122 in the driving unit 180.

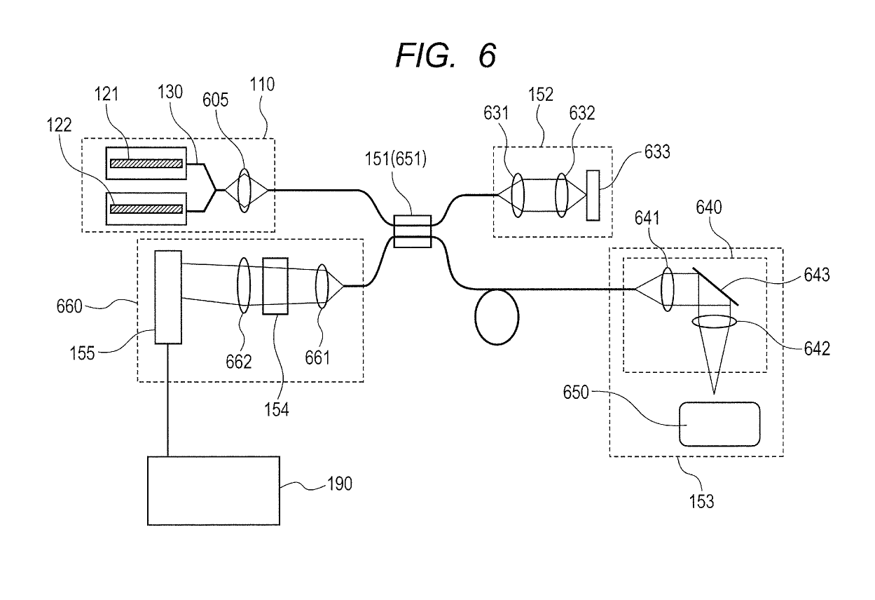

FIG. 6 illustrates a specific configuration of the photoreceptor unit 150 in FIG. 1, which is applied to the SD-OCT system. A process of acquiring an optical tomography image will be explained using the figure.

The photoreceptor unit illustrated in FIG. 6 includes the optical splitter 151 splitting beams emitted from the optical output unit 110 into reference beams and measuring beams, the reference beam reflector 152 and the measurement section 153 that includes an irradiation optical system 640 for irradiating a measurement target 650 with beams. Furthermore, an optical combiner 651 that combines reflected reference beams and reflected measuring beams with each other, a spectrum detection unit 660 that acquires optical spectrum information, and the image converter unit 190 that converts the spectral information into an image, are provided.

The optical output unit 110 includes: the SLDs 121 and 122; the combiner section 130 for the photoreceptor unit that combines two emitted beams; and a lens 605 that couples beams into the optical fiber. The optical splitter 151 splits beams into the reference beams and the measuring beams. A part of split beams enters the reference beam reflector 152. Here, the same fiber couplers are adopted as the optical splitter 151 and the optical combiner 651.

The reference beam reflector 152 includes collimator lenses 631 and 632 and a reflecting mirror 633. The beams are reflected by the reflecting mirror 633 and are incident again onto the optical fiber.

The measuring beams, which are the other beams having passed through the optical fiber and been split by the optical splitter 151, enters the measurement section 153. The measuring optical system 640 of the measurement section 153 includes collimator lenses 641 and 642 and a reflecting mirror 643 for bending the optical path by 90°. The irradiation optical system 640 serves a role of allowing the incident beams to be incident onto the measurement target 650 and coupling the reflected beams into the optical fiber again.

The beams returning from the reference optical system 152 and the measurement section 153 pass through the optical combiner 651 and enter the spectrum detection unit 660. The spectrum detection unit 660 includes collimator lenses 661 and 662, the spectrometer 154 and the line sensor 155 for acquiring spectral information on the beams spectroscopically analyzed by the spectrometer 154. A grating is adopted as the spectrometer 154. The spectrum detection unit 660 has a configuration of acquiring spectral information on the incident beams. The information acquired by the spectrum detection unit 660 is converted into an image by the image converter unit 190 for conversion into a tomography image, thereby acquiring tomography image information, which is the final output.

As to driving in this Example using the system, the SLDs 121 and 122 are driven such that the SLD 121 is driven and subsequently the SLD 122 is driven in each photoreception cycle of the line sensor 155 in the photoreceptor unit 150. On the SLDs 121 and 122, driving is started and completed in the photoreception cycle. The SLDs are not simultaneously driven. The drive time for the SLDs 121 and 122 are the same. The photoreception cycle and the time cycle until next driving of each SLD are the same. Adjustment of the driving current for SLDs 121 and 122 allows the combined spectrum in the photoreception cycle to have a desired shape.

Thus, a desired spectrum can be acquired by driving the SLDs 121 and 122 in the photoreception cycle. The spectrum can be monitored when driving only one of the SLDs, and feedback can be performed.

Here, the desired spectral shape may be unimodal. However, a tomographic image may be acquired as long as the spectral shape has the amount of side lobes in Fourier transform, which causes blurring in the acquired tomographic image, being equal to or less than a predetermined value. Accordingly, the spectral shape control by the control unit 170 and the driving unit 180 is adjusted so as to continuously control the spectral shape within this allowable range.

Variation in optical spectrum due to variation in driving current for the SLDs 121 and 122 in this Example is as follows. In the A-MQW in this Example, as the driving current increases, an emission intensity on the short wavelength side increases. With a driving current of 50 mA, a unimodal spectrum can be confirmed. Meanwhile, with a driving current of 100 mA, a peak appears on a short wavelength side and thus the spectral shape has two peaks. If driving is performed with 50 mA for the SLD 121 and 100 mA for the SLD 122, an approximately unimodal spectral shape can be acquired by combining of both the emitted beams. In this Example, the SLD 121 is driven around 50 mA, and the SLD 122 is driven around 100 mA. The spectral shape is controlled within a predetermined range so as to acquire an image at any time.

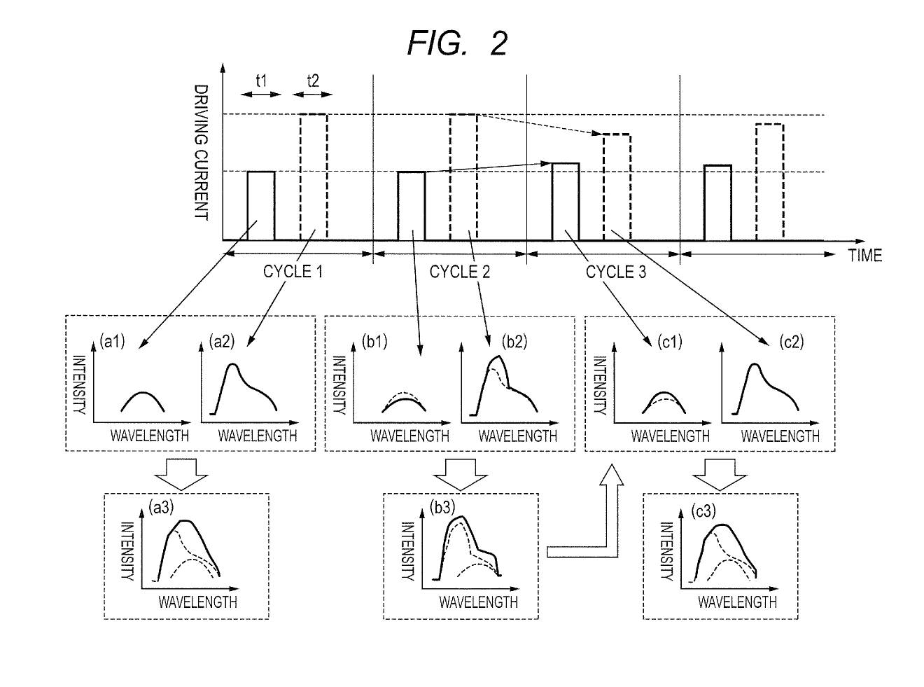

FIG. 2 illustrates variation in driving current values for SLDs 121 and 122 with time, together with the photoreception cycle. The photoreception cycle is 50 μs. The drive time for each of SLDs 121 and 122 is 10 μs. The SLD 121 is driven 5 μs to 15 μs after the start of the photoreception cycle. The SLD 122 is driven from 20 to 30 μs after the start.

In a photoreception cycle 1, in time t1 during which the SLD 121 is driven, the spectral shape of the SLD 121 is measured by the line sensor 162 of the monitor unit 160. In time t2 during which the SLD 122 is driven, the spectral shape of the SLD 122 is measured by the line sensor 162 of the monitor unit 160. The spectral shapes of the SLDs 121 and 122 can thus be measured, and based on the result, the spectral shape in which the SLDs 121 and 122 are combined can be read out. If the result deviates from the desired spectral shape, the driving current for the SLD 121 and 122 in the next photoreception cycle 2 is determined so as to adjust the shape before driving the SLDs 121 and 122 in the photoreception cycle 2.

In the photoreception cycle 2, with the driving current based on the result of the photoreception cycle 1, the SLDs 121 and 122 are driven, each spectrum is monitored again, and feedback is performed. These processes are repeated thereafter. Thus, the spectral shape can be controlled within the predetermined range, even when the spectral shape begins to change owing to heat.

For instance, in FIG. 2, in the case where the SLD 121 is driven with 50 mA and the SLD 122 is driven with 100 mA in the photoreception cycle 1, a spectral shape of the SLD 121 is measured as illustrated as (a1) and a spectral shape of the SLD 122 is measured as illustrated as (a2), and the combined spectrum thereof has a unimodal spectral shape as illustrated as (a3).

In the photoreception cycle 2, as with the photoreception cycle 1, the SLD 121 is driven with 50 mA and the SLD 122 is driven with 100 mA. At this time, it is assumed that decrease in intensity is measured on the spectrum (b1) of the SLD 121 in comparison with (a1), and increase in intensity on a short wavelength side is measured on the spectrum (b2) of the SLD 122 in comparison with (a2). In this case, the combined spectrum (b3) has a shape deviating a little from the unimodality.

Thus, in a photoreception cycle 3, adjustment is performed such that the SLDs 121 and 122 have respective spectra (c1) and (c2) and combined spectrum (c3) has a unimodal shape. Specifically, the driving current for the SLD 121 is increased to 55 mA, and the driving current for the SLD 122 is decreased to 95 mA.

As such, even if the shape of the combined spectrum deviates, the driving current is adjusted as necessary such that the spectral shape is controlled within a range capable of acquiring a tomographic image. Current and temperature dependence of the spectrum can be measured in advance for the use in the adjustment of the spectrum of each SLD. Here, the drive time for the SLDs 121 and 122 is the same and the drive cycle is also constant to thereby allow reading and adjustment of the spectra to be simplified. However, the spectra may be adjusted by changing the drive time for the SLDs 121 and 122. Since the combined spectrum is an integral value of the outputs, the spectral shape can be controlled to be any of various shapes by changing the drive time for SLDs 121 and 122.

As to feedback of a spectral measurement result, to reflect a result measured in a certain photoreception cycle, the result is fed back to the driving current in the next photoreception cycle. However, in the case where the feedback cannot be performed in time, the feedback may be performed on the driving current two or three cycles thereafter instead of the immediately succeeding photoreception cycle.

The sensor for detecting the spectrum as used herein for the monitor unit 160 can detect at high speed. The drive time for each SLD can be longer than the detection time thereof. Although two SLDs are adopted in the optical source section, three or more SLDs may be adopted. Also in this case, each SLD is not simultaneously driven and they are sequentially driven in turn in a photoreception cycle. In the case of three SLDs, the number of monitor may be two instead of one. Between the monitors, one may monitor emitted beams from the two SLDs, and the other monitor may monitor emitted beams from the remaining SLD.

In the case of monolithically fabricating the optical source section, the combiner section for the photoreceptor unit and the combiner section for the monitor unit as with this Example, adoption of A-MQW as the active layer is more effective. For instance, FIG. 5 illustrates a spectrum in the case of fabricating SLDs having an SLD length of 0.4 mm and a ridge width of 3 μm adopting an InGaAs/Al_{0.2}GaAs, GaAs/Al_{0.2}GaAs and AlGaAs/Al_{0.2}GaAs active layer using an A-MQW having three quantum wells. With a driving current of 50 mA, the spectrum has a narrow half maximum full-width but is unimodal. With a driving current of 100 mA, the half maximum full-width is widened but a peak on a short wave side increases. It can be confirmed that combination of properties with 50 mA and 100 mA acquires a spectrum that has a widened half maximum full-width while it is closer to unimodality. Thus, through use of the A-MQW, the SLDs that have different spectra can be fabricated only by changing the driving current for the SLDs having the same shape.

Note that the formation method, semiconductor materials, electrode materials, dielectric materials are not limited to those disclosed in the embodiment. Instead, another method and materials can be used within the scope of the present invention. For instance, as the substrate, a p-type GaAs substrate may be adopted. In this case, the conductive types of the respective semiconductor layers are changed according thereto. The active layer is not limited to the quantum well structure. Instead, a bulk material and quantum dot may be adopted. Furthermore, the wavelengths and materials are not limited thereto. Instead, luminescent materials, such as GaInP, AlGaInN, AlGaInAsP and AlGaAsSb, may be adopted. The ridge width is not limited to 3 μm. The ridge length is not limited to 0.5 mm. These width and length may appropriately be changed. The SLDs may have different ridge widths and different ridge lengths. In particular, in the case of changing the ridge length of each SLD, the spectral shape and the optical output largely vary. Consequently, different spectral shapes can be acquired even with the same current flowing through each SLD. Each SLD adopts the ridge and the structure where the ridge is inclined. However, any configuration may be adopted that allows operation as SLDs. For instance, a structure suppressing reflectance by a window structure instead of the inclined ridge may be adopted. The optical splitter may be a beam splitter instead of a fiber coupler. The configuration of the monitor unit is not limited to this configuration. Instead, any configuration may be adopted as long as the spectra of emitted beams from the SLDs can be monitored. The Y-branch combiner is adopted as the combiner section. However, this section is not limited thereto. Instead, another combining method having a function capable of combining, such as multi-mode interference (MMI) type, may be adopted. Here, the optical source section, the combiner section for the photoreceptor unit and the combiner section for the monitor unit are monolithically fabricated. Instead, the SLDs of the optical source section may be separately fabricated, and beams therefrom may be combined by a fiber coupler, thereby satisfying this configuration.

### Example 2

In Example 2, in an example of the configuration of an optical tomographic imaging information acquisition apparatus according to an SD-OCT system different from that of Example 1, the optical source section includes two SLDs. In Example 1, the beams are emitted in the two directions, which are used for acquiring a tomographic image and for monitoring. In contrast, in this Example, beams are emitted in one direction from the two SLDs. Furthermore, a splitter unit is provided to split beams after the beams are combined. The split beams are then used for the photoreceptor unit and for the monitor unit. As to a driving method, time is secured for driving only one of each of the two SLDs in a photoreception cycle. The two SLDs are simultaneously driven during other times. A difference from Example 1 will hereinafter be described. The basic structure and the layer configuration are the same as those in Example 1 unless otherwise specifically stated, and the identical symbols are used.

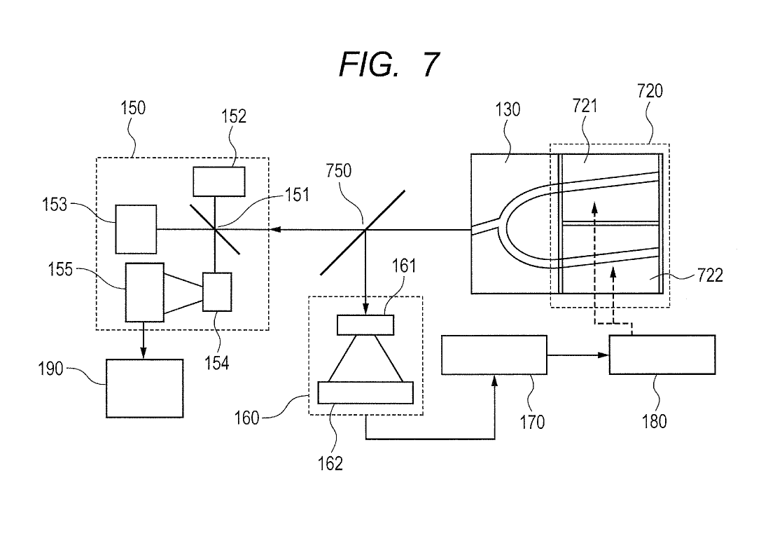

As illustrated in FIG. 7, an SD-OCT system in this Example includes: an optical source section 720 including two SLDs, which are SLDs 721 and 722; a combiner section 130 for the photoreceptor unit that guides emitted beams from the SLDs 721 and 722 to a photoreceptor unit 150; a splitter unit 750 that splits combined beams in which the emitted beams from the SLDs 721 and 722 have been combined by the combiner section 130 for the photoreceptor unit; the photoreceptor unit 150 that receives one of the split beams and acquires information on a measurement target; and a monitor unit 160 including a spectrometer 161 and a line sensor 162 that monitor a spectrum of the other of the split beams.

This system further includes: a control unit 170 that feeds back a monitored result by the monitor unit 160 to a driving unit 180; the driving unit 180 that secures time in which only each one of the SLDs 721 and 722 is driven in a photoreception cycle and simultaneously drives the two SLDs in the other time; and an image converter unit 190 that converts spectral information acquired by the photoreceptor unit 150 into an image.

In comparison with Example 1, this configuration allows the combiner section 130 for the photoreceptor unit to also serve as a combiner section for guiding beams to the monitor unit. Thus, the combiner section for the monitor unit is eliminated and the splitter unit 750 is added. For instance, in the case where, in the SLDs 721 and 722, the optical properties of emitted beams in the two directions are different from each other, correlation therebetween is required to be acquired in Example 1. However, this Example adopts beams having been combined and then split are used for acquiring an image and for monitoring. Consequently, feedback can be easily performed. For instance, in the case of adopting multiple electrodes and applying currents to one SLD according to a method of driving each of the SLDs 721 and 722, the properties of emitted beams from the SLDs 721 and 722 in the two directions are sometimes different. This configuration is effective in such a case.

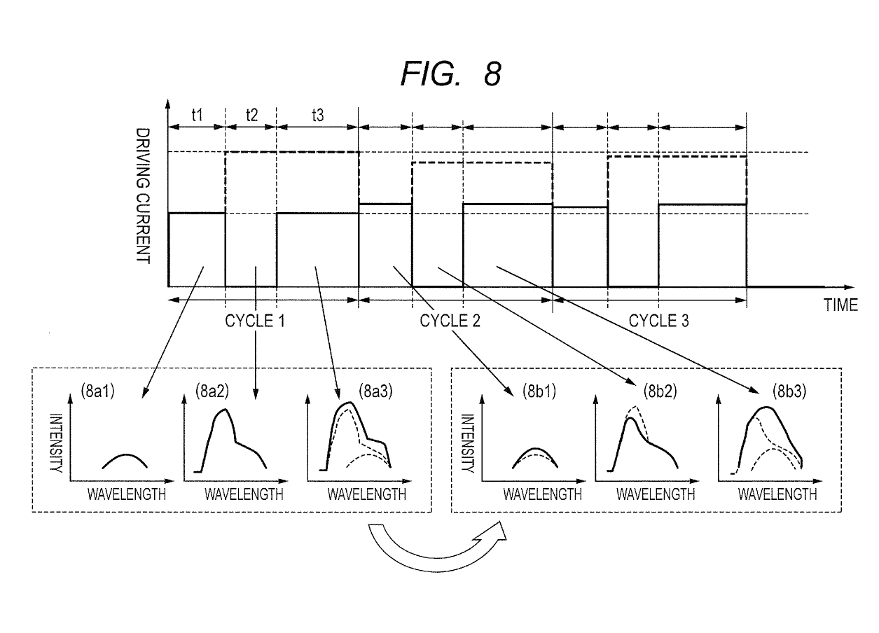

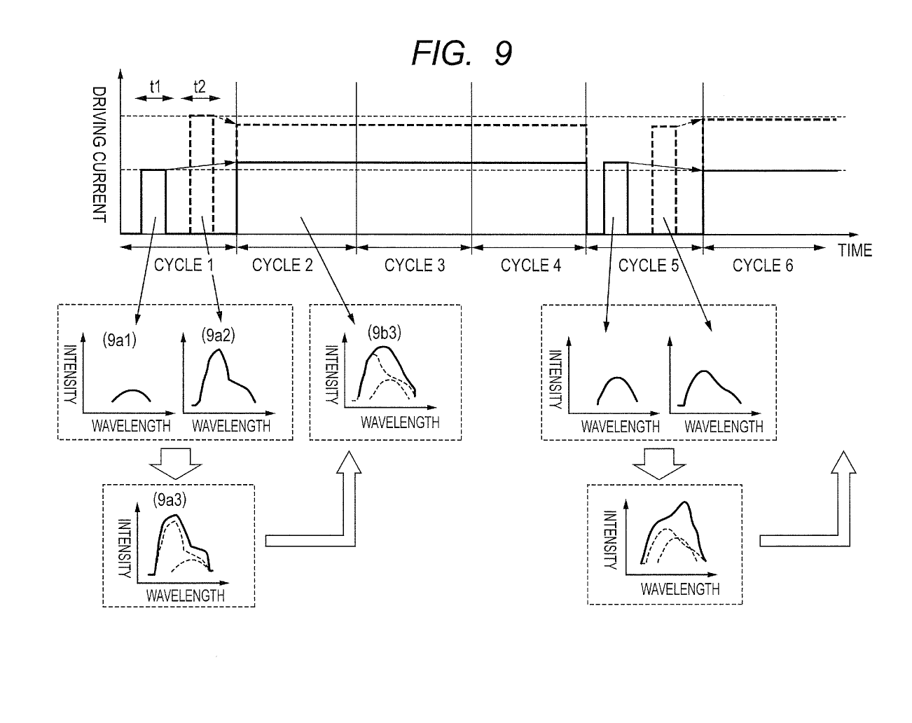

Referring to FIG. 8, a layer structure analogous to that of Example 1 is adopted and each SLD has analogous properties. The SLD 721 is driven around 50 mA. The SLD 722 is driven around 100 mA. The photoreception cycle is 50 μs. The time t1 for driving only the SLD 721 with 50 mA is 10 μs. The time t2 for driving only the SLD 722 with 100 mA is 10 μs. The time t3 for simultaneously driving the SLD 721 with 50 mA and the SLD 722 with 100 mA is 30 μs. Thus, only the predetermined time for driving only each one of the two SLDs is secured in a photoreception cycle; during time other than the predetermined time in the photoreception cycle, the two SLDs are simultaneously driven.

As with Example 1, the driving current for the SLDs 721 and 722 is adjusted, thereby allowing the combined spectrum in the photoreception cycle to have a desired shape.

As illustrated in FIG. 8, the line sensor 162 in the monitor unit 160 measures a spectral shape (8a1) of the SLD 721 in t1 in the photoreception cycle 1, and a spectral shape (8a2) of the SLD 722 in t2. A combined spectrum (8a3) may be calculated from information acquired in t1 and t2. Instead, this combined spectrum may be directly measured in t3. As with Example 1, this result is fed back to the driving current in a photoreception cycle 2.

More specifically, in the photoreception cycle 1, the intensity of the spectrum (8a1) of the SLD 721 is low, and the intensity of the spectrum (8a2) of the SLD 722 is high on a short wavelength side. Consequently, the combined spectrum (8a3) has a shape deviating a little from unimodality. Thus, in the photoreception cycle 2, to correct the shape to be unimodal, the driving current for the SLD 721 is increased to 55 mA and the driving current for the SLD 722 is decreased to 95 mA. Consequently, the combined spectrum (8b3) is adjusted to have a unimodal shape. This driving has the time for causing each SLD to emit beams longer than that in Example 1. Therefore, a more amount of light can be utilized for acquiring an image without waste.

The driving method is not limited thereto. The time for driving only one of the SLDs 721 and 722 is not necessarily continuous as long as the time in which only each one of the two SLDs is driven in a photoreception cycle is secured. The driving may be performed such that only the SLD 721 is driven in t1, the two are simultaneously driven in t31, only the SLD 722 is driven in t2, and the two are simultaneously driven in t32.

Here, the drive time for each of the SLDs 721 and 722 is the same, and the drive cycle is also constant. However, the spectrum may be adjusted by changing the drive time for the SLDs 721 and 722.

### Example 3

Example 3 relates to an example of the configuration of an optical tomographic imaging information acquisition apparatus according to an SD-OCT system different from the above Examples. A difference from Examples 1 and 2 will hereinafter be described.

In this Example, the configuration of the optical tomographic imaging apparatus using the SD-OCT system is analogous to that of Example 1. The optical source section 120 includes two SLDs, which are the SLDs 121 and 122. The basic structure and the layer configuration are the same as those in Example 1 unless otherwise specifically stated, and the identical symbols are used. Instead of the configuration of Example 1, the configuration of Example 2 may be adopted.

As to the driving method, the two SLDs are driven such that time for driving only each one of the SLDs is driven in any photoreception cycle is secured, and both the two SLDs are subjected to continuous wave (CW) driving in the photoreception cycle therebetween.

Here, a layer structure analogous to that of Example 1 is adopted, and each SLD has analogous properties. The SLD 121 is driven around 50 mA. The SLD 122 is driven around 100 mA. The photoreception cycle is 50 μs. In a photoreception cycle 1, the drive time for the SLDs 121 and 122 is 10 μs. The SLD 121 is driven with 50 mA from 5 to 15 μs. The SLD 122 is driven with 100 mA from 20 to 30 μs. As with Example 1, the spectral shape of the SLD 121 is measured in the time t1 for driving the SLD 121 in the photoreception cycle 1, and the spectral shape of the SLD 122 is measured in the time t2 for driving the SLD 122.

As illustrated in FIG. 9, based on monitored results (9a1) and (9a2) of the spectra of the SLDs 121 and 122 in the photoreception cycle 1, each driving current is determined so as to the combined spectrum (9b3) in the photoreception cycle 2 has a unimodal shape. From the photoreception cycle 2 to a photoreception cycle 4, CW driving is performed with each driving current, that is, 55 mA for the SLD 121 and 95 mA for the SLD 122. In a photoreception cycle 5, driving is performed according to a time cycle analogous to that of the photoreception cycle 1. That is, the SLD 121 is driven with 55 mA and the SLD 122 is driven with 95 mA, each for 10 μs. The result is fed back to the driving current in a photoreception cycle 6.

Thus, the two SLDs are driven such that time in which only each one of the SLDs is driven in any photoreception cycle is secured, and the spectrum of each SLD is monitored during the time. In the other photoreception cycles, both the two SLDs are subjected to CW driving. Consequently, even though feedback is not so often performed, the optical output can be efficiently utilized in comparison with Example 1. As to the driving method, in any photoreception cycle in which time is secured for driving only each one of the SLDs, as with Example 2, time may be secured for driving only each one of the two SLDs in a photoreception cycle, and the two SLDs may be simultaneously driven in the other time. Here, CW driving of the two SLDs is performed for three photoreception cycles. Instead, any cycle may be adopted.

### Example 4

Example 4 relates to an example of the configuration of an optical tomographic imaging information acquisition apparatus according to an SD-OCT system different from the above Examples. A difference from Examples 1, 2 and 3 will hereinafter be described.

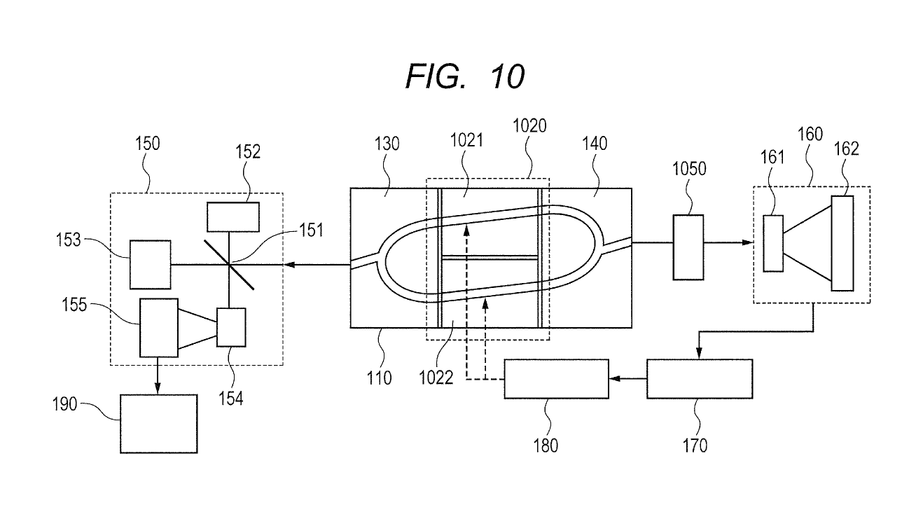

According to this Example, in the configuration of the optical tomographic imaging apparatus using the SD-OCT system, the optical source section includes the two SLDs. A switch (SW) unit is provided so as to be disposed immediately before the monitoring by the monitor unit on the emitted beams from the two SLDs and to allow monitoring of the spectrum at any time. The SW unit is driven so as to allow the spectrum of only one SLD to be monitored in any photoreception cycle. As long as the SW unit is provided, the configuration of either of Example 1 and 2 may be adopted. FIG. 10 illustrates a configuration applicable to Example 1.

An optical source section 1020 includes SLDs 1021 and 1022.

An SW unit 1050 is provided between a combiner section 130 for the monitor unit and a monitor unit 160. For instance, a shutter that blocks beams is adopted as the SW unit 1050. The basic structure and the layer configuration are the same as those in Example 1 unless otherwise specifically stated, and the identical symbols are used. As to the driving method, the two SLDs are driven such that time in which only each one of the SLDs is driven in a photoreception cycle is secured. The SW unit is driven such that the spectrum of only one of the SLDs 1021 and 1022 is monitored in any photoreception cycle.

Here, a layer structure analogous to that of Example 1 is adopted, and each SLD has analogous properties. The SLD 1021 is driven around 50 mA. The SLD 1022 is driven around 100 mA. The drive time for SLDs 1021 and 1022 is analogous to that of Example 1. The photoreception cycle is 50 μs. In a photoreception cycle 1, the drive time for the SLDs 1021 and 1022 is 10 μs, the SLD 1021 is driven with 50 mA from 5 to 15 μs, and the SLD 1022 is driven with 100 mA from 20 to 30 μs. In the photoreception cycles thereafter, driving is performed at analogous time intervals. In the photoreception cycle 1, the shutter of the SW unit 1050 is opened (ON) only when the SLD 1021 is driven, and the shutter is closed (OFF) during the other time.

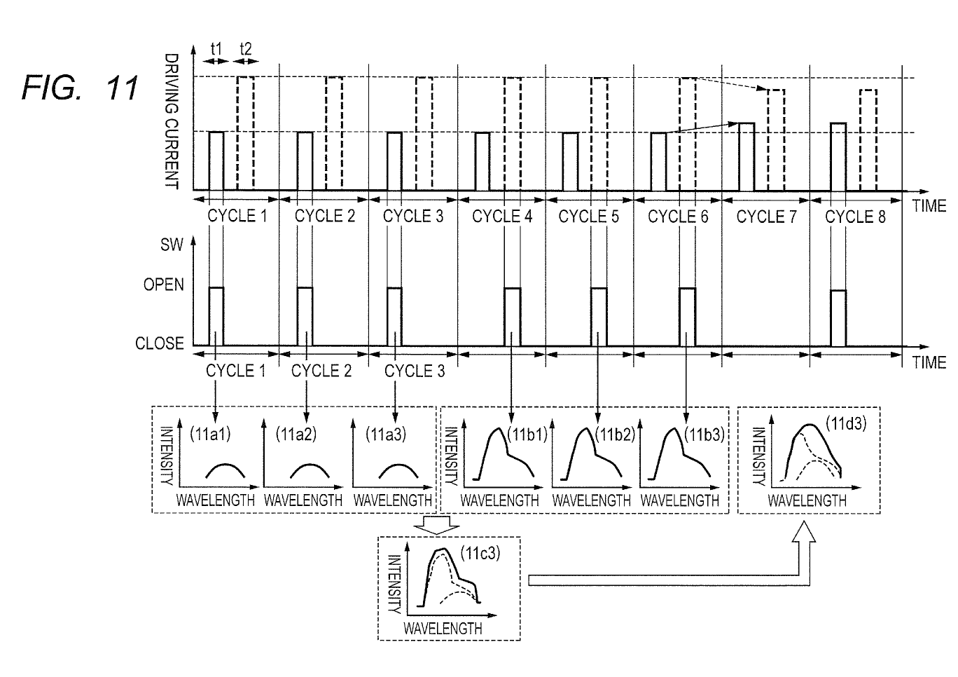

Consequently, as illustrated in FIG. 11, in the photoreception cycle 1, only the spectrum (11a1) of the SLD 1021 is monitored. Also in photoreception cycles 2 and 3, the shutter is opened only when the SLD 1021 is driven and the spectra (11a2) and (11a3) of the SLD 1021 are monitored.

Next, in a photoreception cycle 4, the shutter is opened only when the SLD 1022 is driven; during the other time, the shutter is closed. Consequently, only the spectrum (11b1) of the SLD 1022 is monitored. Also in photoreception cycles 5 and 6, only the spectra (11b2) and (11b3) of the SLD 1022 are analogously monitored. Based on the combined spectrum (11c3), which is results on the SLD 1021 acquired from the photoreception cycle 1 to the photoreception cycle 3 and results on the SLD 1022 acquired from the photoreception cycle 4 to the photoreception cycle 6, the driving current is adjusted such that the combined spectrum (11d3) has a unimodal shape in a photoreception cycle 7.

More specifically, referring to FIG. 11, in the photoreception cycle 7, the SLD 1021 is driven with 55 mA and the SLD 1022 is driven with 95 mA. From a photoreception cycle 8 to a photoreception cycle 10, measurement of the spectrum on the SLD 1021 is repeated.

Thus, the spectrum of each SLD is monitored in a plurality of photoreception cycles. After completion of acquiring the spectrum on each SLD, feedback is performed to the next photoreception cycle. Accordingly, feedback can be performed in any photoreception cycle while acquiring a tomographic image.

This Example is effective in the case where the spectrum is required to be measured by integration for a plurality of photoreception cycles, such as the case where the spectrum of each SLD cannot be monitored in only one photoreception cycle. As to the method of driving the two SLDs, as long as the driving is performed such that time in which only each one of SLDs is driven in a photoreception cycle is secured, time in which only each one of the two SLDs is driven in a photoreception cycle is secured and the two SLDs may be simultaneously driven in the other time as with Example 2. Also in this case, the shutter is driven so as to be opened when only one of the SLDs is driven.

Here, the spectrum of each SLD is monitored for three photoreception cycles. Instead, driving is performed for any number of cycles. The shutter is driven so as to be opened when only one of the SLDs is driven. However, if only one of the SLDs can be monitored, the time during which the shutter is opened is not necessarily identical to the drive time for each SLD. Any SW unit other than the shutter may be adopted, as long as this unit can monitor the spectrum at any time.

Here, the method of driving the SLDs, and the configuration of the SD-OCT system, and particularly the configuration of the optical output unit, which have been described in each Example, are not limited to the combination in each Example. Instead, any possible combination may be adopted. The number of SLDs, the drive time, and the feedback method, which have been described in each Example may be applied to another example within an appropriate range.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-232492 filed Oct. 24, 2011, which is hereby incorporated by reference herein in its entirety.

1. An optical coherence tomographic imaging information acquisition apparatus comprising:
an optical source section including at least two super luminescent diodes;
a photoreceptor unit including a sensor and a spectrometer that are for acquiring information on a measurement target;
a combiner section for the photoreceptor unit configured to combine emitted beams from the at least two super luminescent diodes that are emitted from one end of the optical source section and to guide the beams to the photoreceptor unit;
a monitor unit configured to monitor a spectrum of the emitted beams from the at least two super luminescent diodes in the optical source section;
a driving unit configured to drive the at least two super luminescent diodes; and
a control unit configured to feed back a monitored result by the monitor unit to the driving unit,
wherein the driving unit is further configured to drive, in any photoreception cycle among photoreception cycles, each of which are a cycle time in which the sensor reads a signal, only one of each of the at least two super luminescent diodes.

2. The optical coherence tomographic imaging information acquisition apparatus according to claim 1,
wherein the optical source section is configured to emit the beams in two directions that are the one end and the other end, and
the optical coherence tomographic imaging information acquisition further includes a combiner section for the monitor unit configured to guide beams emitted from the other end to the monitor unit.

3. The optical coherence tomographic imaging information acquisition apparatus according to claim 1 further comprising:
a splitter unit configured to split the beams combined by the combiner section for the photoreceptor unit into two beams,
wherein one of the beams split by the splitter unit enters the photoreceptor unit and the other of the split beams enters the monitor unit.

4. The optical coherence tomographic imaging information acquisition apparatus according to claim 3,
wherein the combiner section for the photoreceptor unit is further configured to combine the emitted beams from the at least two super luminescent diodes emitted from the optical source section and to guide the beams to the monitor unit.

5. The optical coherence tomographic imaging information acquisition apparatus according to claim 2,
wherein the emitted beams from the one end of the optical source and the emitted beams from the other end have a same optical output.

6. The optical coherence tomographic imaging information acquisition apparatus according to claim 1,
wherein the at least two super luminescent diodes are sequentially driven in turn such that drive time does not overlap in the photoreception cycle, and
the at least two super luminescent diodes are driven such that a total drive time in which all these diodes are driven one time is shorter than the photoreception cycle.

7. The optical coherence tomographic imaging information acquisition apparatus according to claim 1,
wherein time during which only each one of the at least two super luminescent diodes can be driven for a predetermined time in the photoreception cycle is secured, and
during a time other than the predetermined time within the photoreception cycle, the at least two super luminescent diodes are simultaneously driven.

8. The optical coherence tomographic imaging information acquisition apparatus according to claim 1,
wherein the at least two super luminescent diodes are driven such that time during which only each one of the diodes is driven is secured in any of the photoreception cycles, and
these diodes are subjected to continuous driving in a photoreception cycle in other photoreception cycles.

9. The optical coherence tomographic imaging information acquisition apparatus according to claim 1, further comprising
a switch unit configured to allow the monitor unit to monitor, at any time, spectra of the emitted beams from the at least two super luminescent diodes,
wherein the switch unit is driven such that only one of the super luminescent diodes can be monitored in any of the photoreception cycles.

10. The optical coherence tomographic imaging information acquisition apparatus according to claim 1,
wherein the at least two super luminescent diodes are driven such that time during which only each one of these diodes is driven in all the photoreception cycles is secured.

11. The optical coherence tomographic imaging information acquisition apparatus according to claim 1,
wherein the time during which only each one of the at least two super luminescent diodes is driven is longer than time during which the monitor unit detects the spectrum.

12. The optical coherence tomographic imaging information acquisition apparatus according to claim 1,
wherein the control unit is configured to reflect monitored result by the monitor unit in a certain one of the photoreception cycles into the driving unit in the next photoreception cycle, and
the driving unit is controlled so as to drive the at least two super luminescent diodes based on the reflected result.
